(19) United States
(12) Patent Application Publication
(10) Pub. No.: US 2025/0138558 A1
(43) Pub. Date: May 1, 2025

(54) EMERGENCY SYSTEM FOR AN AIRCRAFT

(71) Applicant: Airbus Operations GmbH, HAMBURG (DE)

(72) Inventor: Frederik SOBECK, HAMBURG (DE)

(21) Appl. No.: 18/924,664

(22) Filed: Oct. 23, 2024

(30) Foreign Application Priority Data
Oct. 26, 2023 (EP) 23205948.5

(51) Int. Cl. G05D 1/81; G05D 1/654

(52) U.S. Cl. CPC G05D 1/817; G05D 1/6546

(57) ABSTRACT

An emergency system for an aircraft. The emergency system comprises an autopilot controller arranged in a cockpit of the aircraft and configured to automatically fly the aircraft including performing predefined maneuvers, and an emergency button arranged in a crew rest compartment outside of the cockpit and configured to send an emergency landing signal to the surveillance system and/or the autopilot controller when activated. Also an aircraft section and aircraft.

### CROSS-REFERENCES TO RELATED APPLICATIONS

This application claims the benefit of European Patent Application Number 23205948.5 filed on Oct. 26, 2023, the entire disclosure of which is incorporated herein by way of reference.

### FIELD OF THE INVENTION

The present disclosure generally relates to an emergency system for an aircraft, as well as an aircraft section and aircraft having such emergency system. Particularly, the present disclosure relates to an emergency system including an emergency button outside of the cockpit to send an emergency landing signal. The present disclosure further relates to an aircraft section having such emergency system and an aircraft comprising such aircraft section.

### BACKGROUND OF THE INVENTION

A conventional aircraft is usually equipped with an autopilot system to allow controlling the aircraft during cruise. Some of the autopilot systems include functionality to perform minor climb and descend maneuvers. In addition, some aircrafts or autopilot systems are configured to perform automated maneuvers in case of a signal from a Traffic Collision Avoidance System (TCAS). A more advanced control of the aircraft may even allow an automated landing of the aircraft including Air Traffic Control communication, for example, if the pilot/s is/are unable to continue the flight.

### SUMMARY OF THE INVENTION

It is an object of the present disclosure to provide an aircraft control system for improved safety of the aircraft and passengers.

This object may be solved by the present invention as defined in one or more embodiments described herein.

According to a first aspect to better understand the present disclosure, an emergency system for an aircraft comprises an autopilot controller arranged in a cockpit of the aircraft and configured to automatically fly the aircraft including performing predefined maneuvers, a surveillance system, and an emergency button arranged in a crew rest compartment outside of the cockpit and configured to send an emergency landing signal to the surveillance system and/or the autopilot controller when activated.

Thus, a crew member resting outside of the cockpit, which is common practice during long-haul flights, is capable of initiating an emergency landing procedure, although not being physically in the cockpit. This allows the crew member outside of the cockpit to solve critical situations as if being in the cockpit, and valuable time is not lost, for example, until the crew member has left the crew rest compartment and reached the cockpit.

Such emergency system further allows to reduce the number of “standby” or backup crew members providing economic benefits for the aircraft operator (e.g., an airline). As a mere example, during take-off and landing/approach two pilots are in the cockpit and fly (operate) the aircraft. However, during uncritical flight phases, such as climb, cruise, and initial decent, it is sufficient to have only one pilot in the cockpit.

It is to be understood that the surveillance system can be integrated into the autopilot controller. Thus, the aircraft can either be equipped with a conventional autopilot controller supplemented with the surveillance system, according to the present disclosure, or the autopilot controller is exchanged with an autopilot controller including the functionality of the surveillance system, according to the present disclosure. Such replacement of the autopilot controller includes updating a software/firmware executed on the autopilot controller.

In an implementation variant, the emergency system can further comprise a camera arranged in the cockpit and configured to capture an image of the cockpit, and a user interface device arranged in the crew rest compartment and configured to display the captured image from the camera. This allows the crew member in the crew rest compartment to see a live video stream of the cockpit and facilitates assessing the situation by the resting crew member.

As a mere example, the camera can be configured to capture an image of a section of the cockpit including a pilot seat. Thus, the resting crew member can assess whether the remaining (sole) pilot in the cockpit may not be able to handle the situation or may even be hampered to fly the aircraft. For instance, the pilot in the cockpit may be unconscious or may have a difficult health situation hindering the pilot from operating the aircraft properly. Of course, the resting crew member can go back to the cockpit without pressing the emergency button, for example, in less critical situations.

In another implementation variant, the display device can be further configured to display one or more alert messages indicated on a control panel in the cockpit. In other words, in case of alert messages being provided inside of the cockpit, such alert messages may be presented in the same or at least similar manner to the crew member in the crew rest compartment. Alternatively or additionally, the user interface can be configured to output a visual and/or audible alarm, in order to notify that an alert message is being displayed.

In yet another implementation variant, the surveillance system can be configured to monitor a physical condition and/or health of a pilot in the cockpit, to determine whether the pilot is hampered of operating the aircraft, and to send an alarm signal to the user interface device, if it is determined that the pilot is hampered based on the physical condition and/or health of the pilot. The alarm signal can be a visual and/or audible signal. Particularly, the alarm signal in the crew rest compartment can be a bright light, an alert message displayed, a sound, a noise, a vibration or the like, intended to wake up the resting crew member and/or directing the attention of the resting crew member to the user interface device.

Monitoring the physical condition and/or health of the pilot can be performed, for example, on the basis of the camera image. Health monitoring and fatigue recognition can be performed on image signals as well as audio surveillance of the cockpit. Thus, the surveillance system may analyze image data from the camera and/or audio data from a microphone or similar audio input device in the cockpit, to determine whether the (remaining) pilot in the cockpit is able to fly the aircraft. Such health monitoring and fatigue recognition can be based on a conventional pilot/driver monitoring system (for example, as they are also available for cars).

In an implementation variant, the emergency button can comprise a security measure, preferably an authentication means. As a mere example, the emergency button may be operated with a key that is only available to the crew member (pilot). Alternatively or additionally, the security measure may comprise entering a pin, password or other authentication credentials, such as a fingerprint or iris recognition, before the emergency button can be activated. This increases the overall security, so that the emergency button is not unintentionally triggered and the automated landing maneuver is not unintentionally initiated.

According to a second aspect to better understand the present disclosure, an aircraft section comprises a cockpit, at least one crew rest compartment located outside of the cockpit, and an emergency system of the first aspect or one or more of its implementation variants.

Thus, the crew member (pilot) currently on standby or resting is able to initiate an automated landing maneuver and can safe valuable time before leaving the crew rest compartment and entering the cockpit to take over manual control of the aircraft. This significantly increases safety of the aircraft and, hence, of the crew and passengers, as valuable time can be saved in critical situations.

As a mere example, the crew rest compartment can be in a crown area of the aircraft or in a belly or cargo area, i.e., underneath the cabin floor. Both areas are usually reached through a small staircase or ladder, which can only be passed slowly.

It is to be understood that the emergency button and/or the user interface device may also be disposed in other aircraft sections, where flight personal operates or rests. As a mere example, well-trained flight attendants may be alerted via the user interface device and can assess the situation and the cockpit, and may even be authorized to activate the emergency button, and, hence, initiate the automated emergency landing maneuver of the aircraft.

According to a third aspect to better understand the present disclosure, an aircraft comprises an aircraft section of the second aspect.

The present disclosure is not restricted to the aspects and variants in the described form and order. Specifically, the description of aspects and variants is not to be understood as a specific limiting grouping of features. It is to be understood that the present disclosure also covers combinations of the aspects and variants. Thus, each variant or optional feature can be combined with any other aspect, variant, optional feature or even combinations thereof.

In the following, the present disclosure will further be described with reference to an exemplary implementation illustrated in the sole Figure schematically illustrating an aircraft section having an emergency system.

In the following description, for purposes of explanation and not limitation, specific details are set forth in order to provide a thorough understanding of the present disclosure. It will be apparent to one skilled in the art that the present disclosure may be practiced in other implementations that depart from these specific details.

### BRIEF DESCRIPTION OF THE DRAWING

Embodiments of the invention are described in more detail with reference to the accompanying drawing listed below.

FIG. 1 schematically illustrates an aircraft section having an emergency system.

### DETAILED DESCRIPTION OF THE PREFERRED EMBODIMENTS

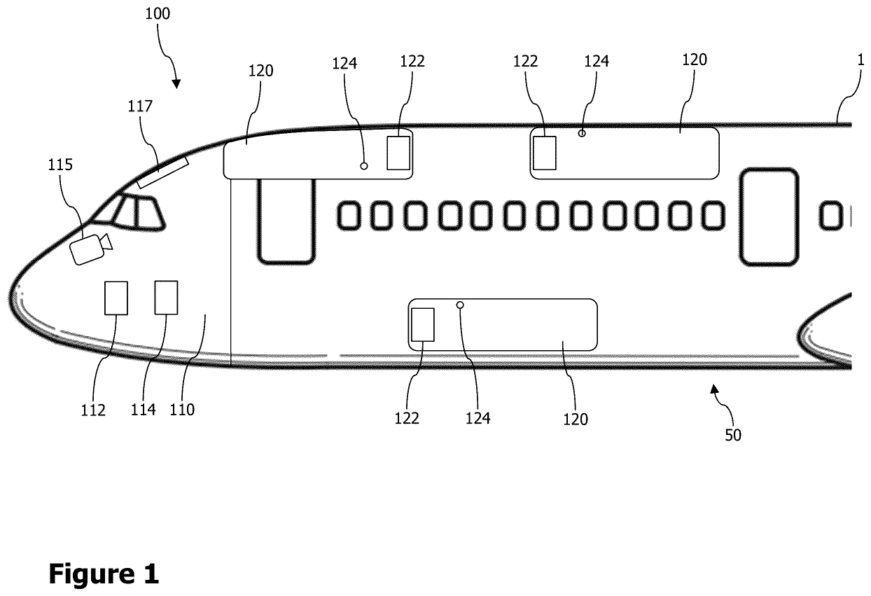

FIG. 1 schematically illustrates an aircraft section 50 having an emergency system 100. Specifically, an aircraft 1 comprises an aircraft section 50 including a cockpit 110 and at least one crew rest compartment 120. FIG. 1 exemplarily illustrates three crew rest compartments 120, two in a crown area, and one crew rest compartment 120 and a cargo area, i.e., beneath a cabin floor (not illustrated). Each crew rest compartment 120 is arranged outside of the cockpit 110, and it may take some time (e.g., a few minutes, such as one, two or even five minutes) for a crew member to leave the crew rest compartment 120 and reach the cockpit 110.

In the cockpit, an autopilot controller 112 is provided that is configured to automatically fly the aircraft 1. The autopilot controller 112 is further capable of performing predefined maneuvers, such as following a particular (predefined and/or pre-programmed) flight route. This includes that the autopilot controller 112 operates the aircraft 1 to descent, climb, and cruise. Such autopilot controller 112 may be a conventional autopilot controller.

The emergency system 100 of the present disclosure additionally includes a surveillance system 114 and an emergency button 124. Specifically, the surveillance system 114 can be provided in or at the cockpit 110 and may be configured to communicate with the autopilot controller 112, particularly to send a control signal to the autopilot controller 112. The emergency button 124 is arranged in the crew rest compartment 120, i.e., outside of the cockpit 110. The emergency button 124 is arranged in such a manner that a resting crew member can activate the emergency button 124 before going to the cockpit 110. It is to be understood that the emergency button 124 may likewise be arranged at an entrance or close to the crew rest compartment 120 or at any other location outside of the cockpit 110.

In any case, the emergency button 124 is configured to send an emergency landing signal to the surveillance system 114. The surveillance system 114 may then be configured to initiate an emergency landing sequence (flight procedure) at the autopilot controller 112 (which emergency landing sequence may be conventionally installed in the autopilot controller 112 or may be installed when the aircraft 1 is retrofitted with the emergency system 100 of the present disclosure).

Alternatively or additionally, the emergency button 124 may directly send an emergency landing signal to the autopilot controller 112 (if the autopilot controller 112 is configured to receive and process such signal).

Thus, once the emergency button 124 is activated, an automatic emergency landing maneuver is initiated, so that the aircraft can, for example, begin to decent (e.g., under control of the autopilot controller 112 or other emergency flight means, e.g., TCAS-alert based devices). This saves valuable time in case of an emergency, if the resting crew member is the sole member handling a critical situation, but is currently not in the cockpit 110.

The emergency system 100 can further comprise a camera 115 arranged in the cockpit 110 and configured to capture an image of the cockpit. As illustrated in FIG. 1, the camera 115 can capture an image of a section of the cockpit including a pilot seat.

The surveillance system 114 may be configured to analyze the captured image from the camera 115, in order to monitor a physical condition and/or health situation of a member (pilot) in the cockpit 110. The surveillance system 114 may further be configured to determine whether the crew member is hampered of operating the aircraft 1, i.e., is hindered or unable to control the aircraft 1, and if so, send an alarm signal to the crew rest compartment 120. Specifically, the surveillance system 114 can send such alarm signal to a user interface device 122 arranged in the crew rest compartment 120 (or close thereto).

Furthermore, the user interface device 122 can be configured to display the captured image from the camera 115. This allows the resting crew member to have a real-time view into the cockpit 110, although currently being outside of the cockpit 110. Thus, the crew member can assess the situation and, if necessary, press the emergency button 124.

It is to be understood that the emergency button 124 can be a physical button (hard key) that can be pressed to activate the emergency landing maneuver. Alternatively or additionally, such emergency button 124 can be provided on the user interface device 122, for example, in form of a so-called soft key (displayed button). The user interface device 122 may be equipped with one or more physical buttons that can be related to such soft keys and/or can be configured as a touchscreen (a display screen including a touch input capability).

In case of a touch screen forming the user interface device 122, authentication means can be easily, including displaying of input fields for user credentials, such as username and password, a pin or the like. Moreover, a fingerprint recognition or iris recognition can be provided at or in the user interface device 122, in order to authenticate the crew member when the emergency button 124 is activated/triggered.

In case of a hard key, security measures, such as authentication means can also be provided. One measure would be that the emergency button 124 can only be activated when using a key.

It is to be understood that combinations of hard key and soft key inputs are required to activate the emergency button 124.

A further optional feature of the surveillance system 114 is an input means that can be activated by the (remaining) crew member in the cockpit 110. In this case, the surveillance system 114 sends the alert message to the user interface device 122 and/or triggers an alarm signal in or near the crew rest compartment 120. As a mere example, in case of the crew member in the cockpit 110 can feeling not well, and alert to the other crew member in the crew rest compartment 120 can be initiated.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

It is believed that the advantages of the technique presented herein will be fully understood from the foregoing description, and it will be apparent that various changes may be made in the form, constructions and arrangement of the exemplary aspects thereof without departing from the scope of the disclosure or without sacrificing all of its advantageous effects. Because the technique presented herein can be varied in many ways, it will be recognized that the disclosure should be limited only by the scope of the claims that follow.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An emergency system for an aircraft, comprising:
an autopilot controller arranged in a cockpit of the aircraft and configured to automatically fly the aircraft including performing predefined maneuvers;
a surveillance system; and
an emergency button arranged in a crew rest compartment outside of the cockpit and configured to send an emergency landing signal to the surveillance system, the autopilot controller, or both when activated.

2. The emergency system of claim 1, further comprising:
a camera arranged in the cockpit and configured to capture an image of the cockpit; and
a user interface device arranged in the crew rest compartment and configured to display the captured image from the camera.

3. The emergency system of claim 2, wherein the image of the cockpit includes a pilot seat.

4. The emergency system of claim 2, wherein the user interface device is further configured to display one or more alert messages indicated on a control panel in the cockpit, or
wherein the surveillance system is configured to monitor a physical condition, a health, or both of a pilot in the cockpit, to determine whether the pilot is hampered from operating the aircraft, and to send an alarm signal to the user interface device, when the physical condition, the health, or both is determined to be hampered, or
both.

5. The emergency system of claim 1, wherein the emergency button comprises a security measure, preferably an authentication means.

6. The emergency system of claim 5, wherein the security measure comprises an authentication means.

7. An aircraft section, comprising:
a cockpit;
at least one crew rest compartment located outside of the cockpit; and
the emergency system of claim 1.

8. An aircraft comprising:
the aircraft section of claim 7.
